(19) United States
(12) Patent Application Publication
(10) Pub. No.: US 2003/0092454 A1
(43) Pub. Date: May 15, 2003

(54) One step SMS message board and time management tools

(76) Inventors: Amin Halim, Singapore (SG); Kaman Halim, Jararta Selacton (ID)

Correspondence Address: JEFFREY FURR, 253 N. MAIN STREET, JOHNSTOWN, OH, 43031, US

(21) Appl. No.: 09/683,068

(22) Filed: Nov. 15, 2001

(51) Int. Cl. H04Q 7/20

(52) U.S. Cl. 455/466; 455/412

(57) ABSTRACT

The present invention provides a process that allows for SMS transmissions to be sent to a Message Board with time management tools such as a “To Do List”an d “Reminder” in a typical Calendar Planning software to send the messages to pre-selected wireless devices and to be able to send those message in a delayed transmission. Electronic messages may be transmitted over a wireless connection to or to and from a mobile. For example, electronic messages addressed to a mobile phone may be received by the gateway of the present invention from the Internet, a LAN, or any other source, warehoused until the proper time and routed to the appropriate mobile phone. Such electronic messages may be originated manually or may be automatically generated by specific computer applications, such as a scheduling program operating on a LAN.

### BACKGROUND OF INVENTION

1. Field of the Invention

The present invention relates generally to a system for providing wireless messaging and specifically to a system for management tools, delayed messaging, and calendar planning assistance.

2. Description of Prior Art

The Short Message Service (SMS) is the ability to send text messages to and receive text messages from mobile telephones. The text can be comprised of words or numbers or an alphanumeric combination. SMS was created as part of the GSM Phase 1 standard. The first short message is believed to have been sent in December 1992 form a Personal Computer (PC) to a mobile phone on the Vodafone GSM network in the United Kingdom. Each short message is up to 160 characters in length when Latin alphabets are used and 70 characters in length when non-Latin alphabets such as Arabic and Chinese, are used.

There is no doubt in the success of the Short Message Service with the market in Europe alone having reached over three billion short messages per month.

Short Message Services are provided by operators of wireless communication systems today who have digital service available. Short Message Services, or more simply put “SMS,” are messages delivered by the wireless network to a digital phone. There are three major digital standards commonly deployed throughout the US today: Code Division Multiple Access (“CDMA”), Time Division Multiple Access (“TDMA”), and Global Systems for Mobile (“GSM”).

Global Systems for Mobile (“GSM”) is a specification that was written to provide a unified digital platform that all 12 countries of the European Community (“EC”) could use from one country to the next with the same phone. Other countries outside of the EC have adopted GSM as their preferred system specification therefore increasing the volume of systems worldwide. The first systems went commercial in 1993 in Europe, while the first commercial GSM system in the United States went commercial at the end of 1995.

GSM is similar to IS-54 TDMA (see below) in that it uses FDMA to separate RF carriers and TDMA to serve up to 8 users per channel. It was developed to provide a single European standard and to facilitate many new enhanced services and automatic roaming. Initially, GSM used the 900 Mhz band but has now added two compatible standards: DCS1800 at 1.8 Ghz and PCS1900 at 1.9 Ghz. TDMA (or D-AMPS) began life as a digital upgrade to the 800 Mhz AMPS network and is commonly referred to as IS-54. It employs the 30 kHz AMPS channel split into three timeslots with a separate control channel. The standard was upgraded to IS-136 to include an integrated digital control channel and interband operability to 1900 Mhz. CDMA was developed to provide further capacity enhancements over the TDMA standards. It uses Direct Sequence Code Division Multiple Access to differentiate users on the same 1.28 Mhz frequency band. CDMA systems are currently operating at 800 Mhz and 1900 MHz.

The US and other countries also decided that there was enough demand for wireless services in the marketplace to introduce more competitors into each market. The amount of new competitors has varied from country to country, but they have consistently used the higher frequency band in the 1900 MHz band. This new license area is generally known as Personal Communication Services (“PCS”), and six new licensed providers have been introduced in each market throughout the US. The two existing operators are generally referred to as “Cellular” operators and operate in the 800 MHz band throughout the US.

U.S. Pat. No. 5,878,351 discloses a method and apparatus for providing delayed transmission of SMS delivery acknowledgment, manual knowledgement, and SMS messages; it allows for the buffering of transmissions and the ability to send those buffered messages at a later date. It does not, however, have those buffered transmissions being sent at a user defined date.

Japanese Patent 10004432A2 discloses an Electronic mail service gateway, a short message processor communication system, and an electronic mail transmission method to mobile terminal equipment. It is a mobile communication network (GSMN) that is provided with a short message service center SMSC. Then a gateway MSG is provided with a decomposing means that decomposes an electronic mail message so as to generate a sequence of a data block led by a mobile communication network and an insert means that inserts continuous data blocks of a succeeding short message, uses the short message services and supplies the short message to a short message port SMP of a mobile communication network led to mobile terminal equipment.

U.S. Pat. No. 5,678,179 by Turcotte, et al. discloses a Message transmission system and method for a radio-communication system. It is a method and system for message signaling in a radio-communication system.

U.S. Pat. No. 6,134,432 by Holmes, et al. discloses a system and process for allowing wireless messaging. It discloses a bi-directional (and/or uni-directional) multiplexing messaging gateway for wireless devices, such as for devices using the Global System for Mobile Communication (GSM) wireless digital standard, or any other suitable protocols.

U.S. Pat. No. 6,061,718 by Nelson discloses an Electronic mail delivery system in wired or wireless communications system. It is an electronic mail (E-mail) delivery system for delivering E-mail messages to and from a subscriber station in a wireless or wired communications system. The E-mail delivery system converts E-mail messages sent to the subscriber station from text to speech for delivery to the subscriber station. Furthermore, the E-mail delivery system converts E-mail messages sent by the subscriber station from speech to text for delivery to a remote destination.

There is still room for improvement within the art.

### SUMMARY OF INVENTION

It is a general object of the present invention to have a process that allows SMS transmissions to be sent to a Message Board with time management tools such as a “To Do List” and “Reminder” in a typical Calendar Planning software to send the messages to pre-selected wireless devices and to be able to send those message in a delayed transmission.

The current invention is the one step of sending of SMS messages to an Internet, Intranet and/or Extranet's Message Board to provide time management tools such as a “To Do List” and “Reminder” with Calendar Planning software, with the option to send the messages to pre-selected wireless devices. The current invention also has delayed transmission innovation in the above mentioned applications.

The users would log on to a Web site through the Internet. The site would contain the time management software tools. The User would use this software to enter to do list and reminders.

The current invention is going to send SMS from the web site to a Mobile Phone user. The process is as follows:

Site Web Server--->SMS server--->Users' mobile phone.

What the system has to do is send the message from the system's web site to the Mobile Operator SMS server. Then the Mobile Operator SMS server sends the message to the mobile phone through its preexisting system. The system sends the SMS from the central location to the Mobile Operator SMS server using the protocol that is used by Mobile Operator. For example, if the Mobile Operator is using the following format: “Mobile Phone Number, Message “The system will just use the same format to send the SMS to the SMS server. For example: “98761234, test “if the Mobile Operator's SMS server is accessible from Internet, any computer that is connected to Internet can contact that SMS server as long as the access privilege is granted by Mobile Operator. The Mobile Operator's SMS server is contacted through the Internet by a process that is similar to contacting a web site from your computer using a browser. This will be done by the system through the use of software (similar to a browser) in system to contact the Mobile Operator SMS server and send the SMS using the protocol that they are using.

### BRIEF DESCRIPTION OF DRAWINGS

Without restricting the full scope of this invention, the preferred form of this invention is illustrated in the following drawings:

FIG. 1 is a block diagram of a mobile station that is constructed and operated in accordance with this invention;

FIG. 2 is an elevational view of the mobile station shown in FIG. 1, and which further illustrates a cellular communication system to which the mobile station is bidirectionally coupled through wireless RF links;

FIG. 3 shows a functional diagram of a computer network for accessing the calendar system through the Internet;

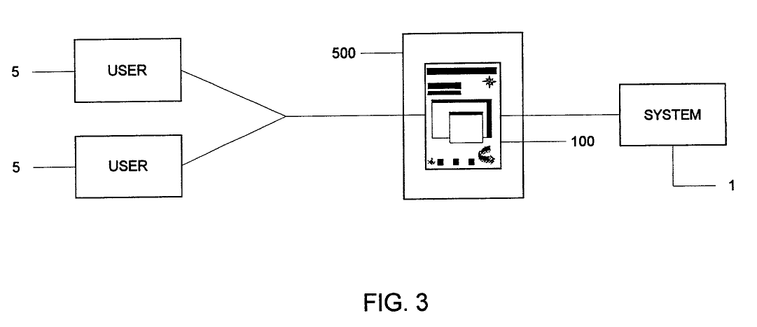

FIG. 4 shows a standard logon web page;

FIG. 5 shows the example of how events are entered in a calendar system web page;

FIG. 6 show another example of how to enter events;

FIG. 7 is a logic flow diagram that illustrates how a the system reviews event records to see if the SMS event messages should be sent; and

FIG. 8 is a logic flow diagram that illustrates how the system transmits an SMS event messages to the destination address.

### DETAILED DESCRIPTION

Preferred Embodiment

The preferred embodiment of the invention is a process that allows SMS transmissions to be sent to a Message Board with time management tools such as a “To Do List” and “Reminder” in a typical Calendar Planning software to send the messages to pre-selected wireless devices and to be able to send those message in a delayed transmission.

The current invention is the one step of sending of SMS messages to an Internet, Intranet and/or Extranet's Message Board to provide time management tools such as a “To Do List” and “Reminder” with Calendar Planning software, with the option to send the messages to pre-selected wireless devices. The current invention also has delayed transmission innovation in the above mentioned applications.

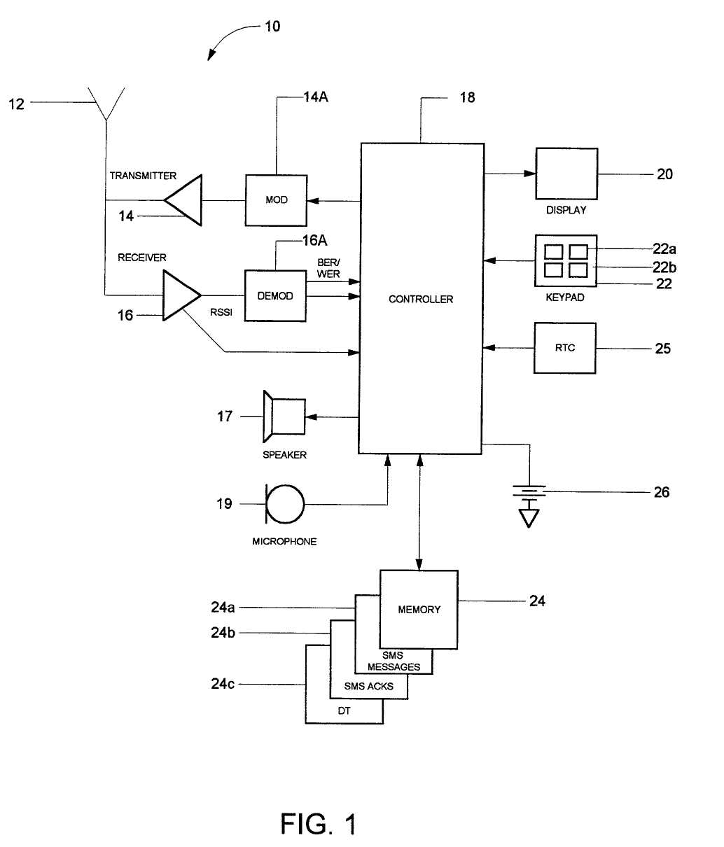

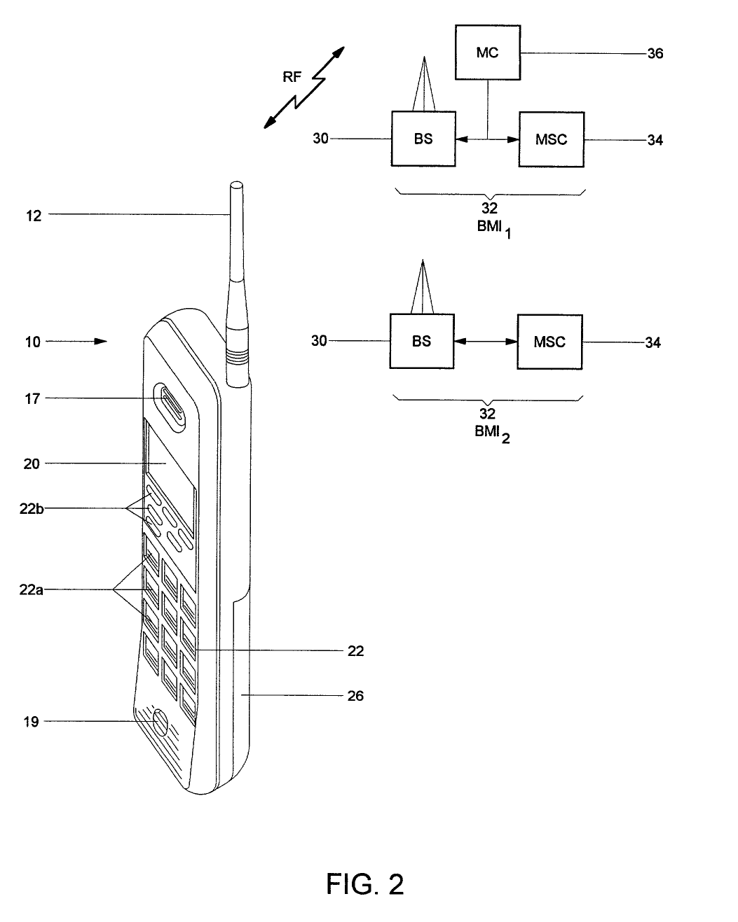

Reference is made to FIGS. 1 and 2 for illustrating a wireless user terminal or mobile station 10, such as, but not limited to, a cellular radiotelephone or a personal communicator that is suitable for practicing this invention. The mobile station 10 includes an antenna 12 for transmitting signals to and receiving signals from a first base site or base station 30. The base station 30 is a part of a first cellular network comprising a Base Station/Mobile Switching Center/Interworking function (BMI.sub.1) 32 that includes a mobile switching center (MSC) 34 and a Message Center (MC) 36. The MSC 34 provides a connection to landline trunks when the mobile station 10 is involved in a call. FIG. 2 also shows a second BMI.sub.2 32′, having associated base station(s) 30′ and MSC 32′. The second BMI 32′ may or may not include a message center.

The mobile station includes a modulator (MOD) 14A, a transmitter 14, a receiver 16, a demodulator (DEMOD) 16A, and a controller 18 that provide signals to and receives signals from the transmitter 14 and receiver 16, respectively. These signals include signalling information in accordance with the air interface standard of the applicable cellular system, and also user speech and/or user generated data. The air interface standard is assumed for this invention to include a physical and logical frame structure of a type that was described above, although the teaching of this invention is not intended to be limited only to this specific structure, or for use only with an IS-136 compatible mobile station, or for use only in TDMA type systems.

It is understood that the controller 18 also includes the circuitry required for implementing the audio and logic functions of the mobile station. By example, the controller 18 may be comprised of a digital signal processor device, a microprocessor device, and various analog to digital converters, digital to analog converters, and other support circuits. The control and signal processing functions of the mobile station are allocated between these devices according to their respective capabilities.

A user interface includes a conventional earphone or speaker 17, a conventional microphone 19, a display 20, and a user input device, typically a keypad 22, all of which are coupled to the controller 18. The keypad 22 includes the conventional numeric (0-9) and related keys (#,*) 22a, and other keys 22b used for operating the mobile station 10. These other keys 22b may include, by example, a SEND key, various menu scrolling and soft keys, and a PWR key. The mobile station 10 also includes a battery 26 for powering the various circuits that are required to operate the mobile station.

The mobile station 10 also includes various memories, shown collectively as the memory 24, wherein are stored a plurality of constants and variables that are used by the controller 18 during the operation of the mobile station. For example, the memory 24 stores the values of various cellular system parameters and the number assignment module (NAM). An operating program for controlling the operation of controller 18 is also stored in the memory 24 (typically in a ROM device). The memory 24 may also store data, including point-to-point and Broadcast SMS messages 24a, that are received from the BMI 32 prior to the display of the messages to the user. In accordance with an aspect of this invention, the memory 24 also stores, when required, any SMS acknowledgement (ACK) messages 24b, such as Delivery ACK and Manual ACK, that cannot be sent when required. Typically, the Delivery ACK message is intended to be transmitted when a corresponding SMS message, which specifies Delivery ACK, is displayed to the user. The Manual ACK is intended to be transmitted in response to an input from the user after reading the corresponding SMS message. Preferably the SMS messages 24a and the buffered acknowledgements 24b are stored in a non-volatile portion of the memory 24 so that this information is not lost should power be removed.

In greater detail, and referring to an IS-136 embodiment, the SMS Manual ACK message is defined to be sent from a mobile station as a result of the user responding to a previously received SMS Deliver message. The mobile station 10 sets a Message Reference in the SMS Manual ACK to the Message Reference in the SMS Deliver message that is being user acknowledged. In addition, the mobile station 10 sets the User Destination Address and User Destination Subaddress in the R-DATA message (see, for example, Section 6.4.3.11) in which the SMS Manual ACK is sent to the User Originating Address (if included) and User Originating Subaddress (if included) in the R-DATA message in which the SMS Deliver message being acknowledged was received.

Reference can be had to commonly assigned and allowed U.S. No. 5,604,921 issued Feb. 18,1997, entitled “Radiotelephone User Interface for Broadcast Short Message Service” by Seppo Alanara.

It should be understood that the mobile station 10 can be a vehicle mounted or a handheld device. It should further be appreciated that the mobile station 10 can be capable of operating with one or more air interface standards, modulation types, and access types. By example, the mobile station may be capable of operating with any of a number of other standards besides IS-136, such as GSM and IS-95 (CDMA). Some narrow-band AMPS (NAMPS), as well as TACS, mobile stations may also benefit from the teaching of this invention, as should dual or higher mode phones (e.g., digital/analog or TDMA/CDMA/analog phones). It should thus be clear that the teaching of this invention is not to be construed to be limited to any one particular type of mobile station or air interface standard.

The operating program in the memory 24 includes routines to present messages and message-related functions to the user on the display 20, typically as various menu items. The memory 24 also includes routines for implementing the methods.

In a first aspect, a presently preferred embodiment of this invention employs point-to-point or point-to-multipoint tele-services that build upon the R-DATA message (see Sections 2.7.3.1.3.2.19 and 3.7.3.1.3.2.23 of IS-136.2, and Sections 6.4.3.11 and 6.4.4.9 of IS-136.1). Each tele-service is identified by a unique value of the higher layer protocol identifier field within the R-DATA unit information element that is included within the R-DATA message. Of most interest herein is the Cellular Messaging Tele-service (CMT), in particular a SMS function that requires either that the Delivery ACK or Manual ACK be transmitted by the mobile station 10 after message presentation to a user.

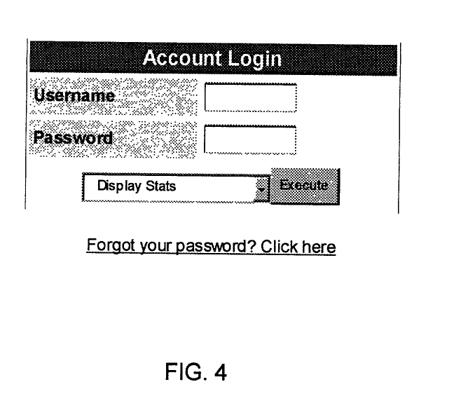

The system 1 would have a standard logon web page as shown in FIG. 4. There would be a data entry field for Username and Password. The Username would have to be unique and the password would have to be at least eight characters. The web page will have a mechanism for Users 5 who forget their password. This technology is well know in the art and therefor is not covered in great detail here.

The FAQ web page would be a standard FAQ web page. This technology is also well know in the art.

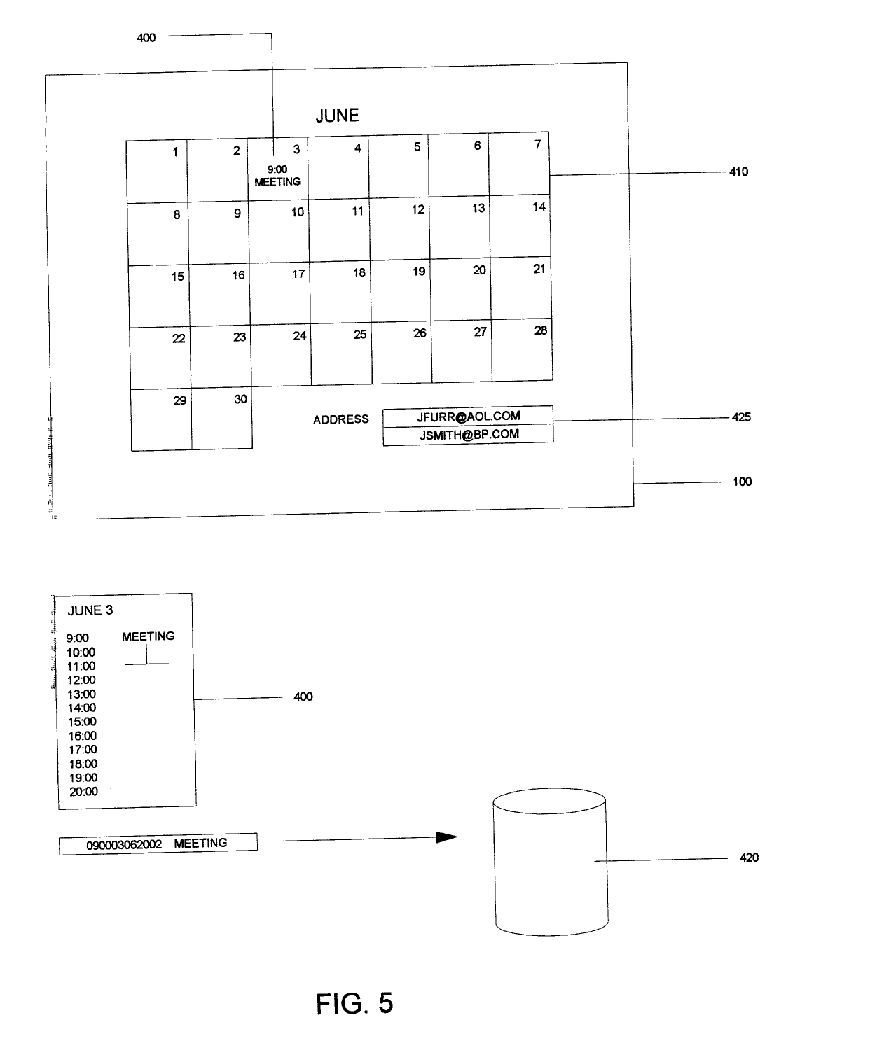

FIG. 5 displays an example of how the Calendar and message board Web Site 100 would look and function. The User 5 would pick out a time and date 400 from the calendar 410 in which to enter an event or reminder 415. The date 400 would be display in more detail broken down by the hours. The User 5 can enter an event on a specific time for that date. This information will be stored in the system 1 event database 420. The events and reminders can be for things such as meetings, due dates, anniversaries, birthdays, and any type of event that the User 5 needs to be reminded of. The User 5 can also enter multiple destination addresses 425. If the User 5 does not enter a destination address then the Users 5 default destination address will be used. A record will be written for each destination address. A User 5 can also choose to re-send or send to someone the event message at a later time, a delayed message. The system 1 will write a new record for either of these situations.

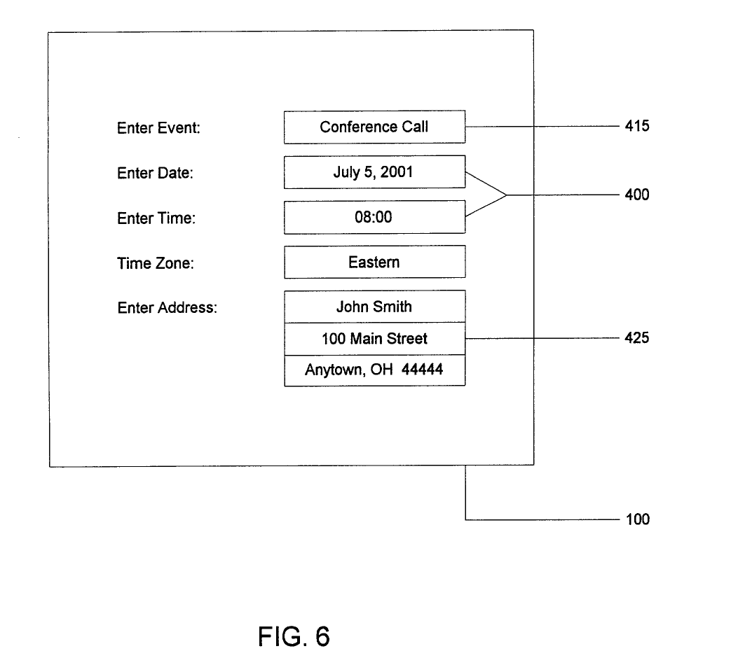

As shown in FIG. 6, another method to enter events into the event database 420. A User 5 enters an event or a reminder 415, then specifies the time and date 400, and then specifies each destination address 425. The times are based on the Users 5 default time zone, although the screen will have an option to choose a time zone. The system 1 will convert all of the times to the system's time zone for date comparisons.

In the preferred embodiment, the system 1 will have time management/project workbench software in which the User 5 will enter the steps of a project, their required time line and the dependency of the sets. The System 1 will calculate the timeline and event dates. The system 1 will load these dates into the event database 420.

The event database 420 will contain a date and time field which is the date and time that the event is to occur and an alpha-numeric description field that describes the event. This description field can be in the User's 5 native language and charactures, from Arabic to English to Chinese. The date and time field will have the format of: MMHHDDMMYYYY, Where MM is the minute, HH is the hour in military time format, DD is the day, MM is the month, and YYYY is the year. The Greco-Roman calendar format is used. The format of the description is a character field with a maximum length of 160 characters when Latin alphabets are used and 70 characters in length when non-Latin alphabets such as Arabic and Chinese, are used. The record will also have the destination address and the preferred SMS operating system to be used.

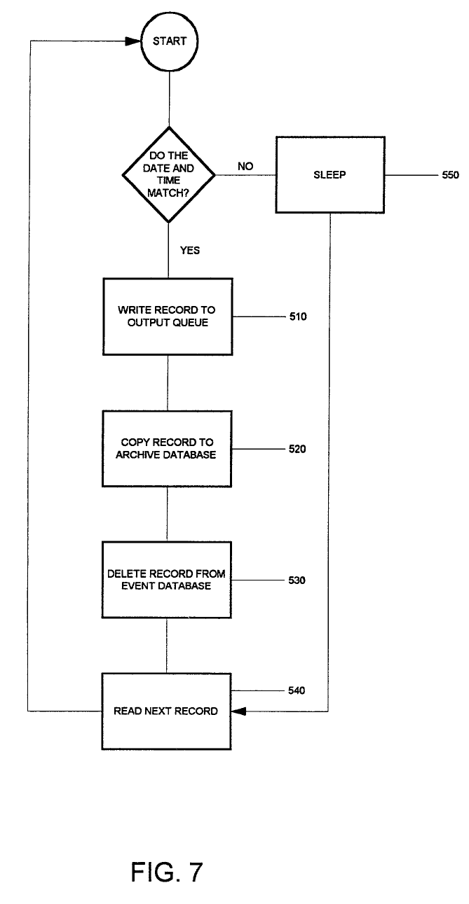

As shown in FIG. 7, the system 1 will review the event database 420. As shown in Block 500, does the ate and time of the event record matches the current date? If yes, the description is written to the output queue 510, the record is moved to the event archive database 520, the record is deleted from the event database 530 and the next record is read 540. If no, then sleep until next time internal 550 and then the first record is reviewed 500. The records in the event database 420 and the event archive database 520 are stored in order of the time and date record with the earliest times first. This mimnmizes the times that the system 1 needs to read the databases.

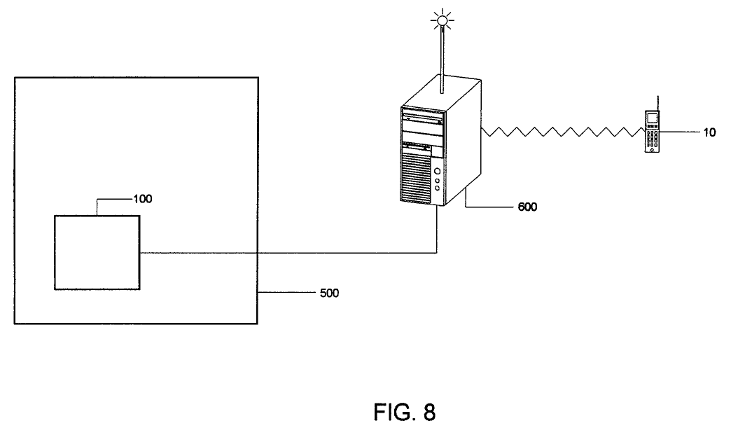

As shown in FIG. 8, the descriptions which are at this point SMS messages are going to be written by the system 1 from a central location to a Moblii Phone user. The process s as follows: C Calendar ite Web Server--->SMS server--->Users' mobile phone.

What the system has to do is send the message from the system”’ web site 100 to the Mobile Operator SMS server 600. Then the Mobile Operator SMS server 600 sends the message to the mobile station 10 through its preexisting system. The system 1 sends the SMS messages from the central location to the Mobile Operator SMS 600 server using the protocol that is used by Mobile Operator. For example, if the Mobile Operator is using the following format:” Mobile Phone Number, Message”T he system will just use the same format to send the SMS to the SMS server.F or example: “98761234, test” If the Mobile Operator”’ SMS server is accessible from Internet, any computer that is connected to Internet can contact that SMS 600 server as long as the access pprivilege s granted by Mobile Operator. The Mobile Operatorr'SMS server is contacted through the Internet by a process that is similar to contacting a web site from your computer using a browser. This will be done by the system through the use of software (similar to a browser) in system to contact the Mobile Operator SMS server and send the SMS using the protocol that they are using.

The SMS event message is transmitted by the SMS server 600 to a cleullar network for transmission to the destination address where it is displayed on the mobile station for viewing by the receiver.

Additional Embodiment

Conclusion, Ramifications, and Scope

Although the present invention has been described in considerable detail with reference to certain preferred versions thereof, other versions are possible. For example, the other protocol or formats could be used or another type of point-to-point communication besides SMS could be used, different record formats can be used, direct connection can be used instead of the Internet to send the records to the SMS Mobile Operator and digital images can be sent instead of text messages. Therefore, the point and scope of the appended claims should not be limited to the description of the preferred versions contained herein.

What is claimed is:

1. A messaging system comprising:
(a) a wireless communication device;
(b) means for originating an electronic message including:
(i) a destination address associated with the wireless communication device; and
(ii) a time and date record at which to send the electronic message, associated with the originating means; and
(iii) an electronic message;
(c) means for performing the steps of:
(i) comparing the time and date with a time and date record;
(ii) creating an electronic message if the time and date match the time and date record; and
(iii) forwarding said electronic message to the wireless communication device via a selected communication connection.

2. The messaging system of claim 1, wherein the wireless communication device comprises a digital mobile phone.

3. The messaging system of claim 1, wherein the originating means comprises a client/server system.

4. The messaging system of claim 1, wherein the originating means comprises a mail server on the Internet.

5. The messaging system of claim 1, wherein the originating means comprises a web site on the Internet.

6. The messaging system of claim 1, wherein the communication connection is the Internet.

7. The messaging system of claim 1, wherein the communication connection is a direct connection from the messaging system to a message operator for transmission to the wireless cocommunication vice.

8. The messaging system of claim 1, wherein the originating means is cacalendar ftware.

9. The messaging system of claim 1, wherein the originating means is cacalendaroftware the is acaccessible rough the Internet.

10. The messaging system of claim 1, wherein the originating means is cacalendaroftware which that writes to a database.

10. The messaging system of claim 1, wherein the originating means is cacalendaroftware which that writes to a database and said database has records that has time and date, destination address and message information.

11. A messaging system comprising:
(a) a wireless communication device;
(b) means for originating an electronic message including:
(i) a destination address associated with the wireless communication device; and
(ii) a time and date record at which to send the electronic message, associated with the originating means;
(iii) an electronic message; and
(iv) cacalendaroftware with a database and said database has records that has time and date, destination address and SMS message information.
(c) means for performing the steps of:
(i) comparing the time and date with a time and date record;
(ii) creating an electronic message if the time and date match the time and date record; and
(iii) forwarding said electronic message to the wireless communication device via a selected communication connection.

12. The messaging system of claim 11, wherein the system reads the database, if the record matches the time then forward a electronic message to the wireless cocommunication vice via a selected communication connection.

13. The messaging system of claim 1, 1 wherein the wireless communication device comprises a digital mobile phone.

14. The messaging system of claim 1, 1 wherein the originating means comprises a client/server system.

15. The messaging system of claim 1, 1wherein the originating means comprises a mail server on the Internet.

16. The messaging system of claim 1, 1wherein the originating means comprises a web site on the Internet.

17. The messaging system of claim 1, 1wherein the communication connection is the Internet.

18. The messaging system of claim 1, 1wherein the communication connection is a direct connection from the messaging system to a message operator for transmission to the wireless cocommunication vice.

19. The messaging system of claim 1, 1wherein the originating means is cacalendaroftware.

20. The messaging system of claim 1, 1wherein the originating means is cacalendaroftware the is acaccessible rough the Internet.
